(19) United States
(12) Patent Application Publication
(10) Pub. No.: US 2017/0356456 A1
(43) Pub. Date: Dec. 14, 2017

(54) HIGH-CAPACITY FLUID PUMP

(71) Applicant: US Fire Pump Company, L.L.C., Ocala, FL (US)

(72) Inventor: Gary Handwerk, Jenkintown, PA (US)

(73) Assignee: US Fire Pump Company, L.L.C., Ocala, FL (US)

(21) Appl. No.: 15/532,664

(22) PCT Filed: Dec. 2, 2015
(86) PCT No.: PCT/US15/63494

§ 371 Date: Jun. 2, 2017

Related U.S. Application Data
(60) Provisional application No. 62/086,590, filed on Dec. 2, 2014.

(51) Int. Cl. F04D 29/44; F04D 29/046; F04D 13/02; F16H 57/04; F04D 29/06

(52) U.S. Cl. CPC F04D 29/448; F16H 57/0417; F16H 57/0471; F04D 29/061; F16H 57/0436; F16H 57/0404; F16H 57/0495; F04D 13/028; F04D 29/046

(57) ABSTRACT

A high-capacity fluid pump comprising a dedicated lubrication system in fluid communication with the pump's drive assembly to reduce wear of internal components within the gearbox, as well as a drive shaft-supported impeller and outboard head to reduce deflection. Moreover, the blades of the outboard head are preferably shaped to decrease the inlet's cross section and stabilize incoming fluid, thereby reducing cavitation, pre-rotation, and turbulent flow at the pump inlet and increasing the overall velocity of incoming fluid.

### CROSS-REFERENCE TO RELATED APPLICATION

This application claims the benefit of U.S. provisional application No. 62/086,590, filed Dec. 2, 2014, which is incorporated by reference.

### BACKGROUND

Fire pumps are utilized to transfer water from either a pumper/tanker fire engine or an outside source (e.g., a fire hydrant or pond) to a burning residential or industrial building. Traditional fire pumps comprise two major assemblies: a drive assembly and fluid pump assembly. The drive assembly features a gearbox for transmitting power from the power source to the pump assembly. Meanwhile, the fluid pump assembly features a an impeller coupled to a pump body, with the pump body controlling and directing the flow of water from the inlet side to the discharge side of the impeller.

Traditional fire pumps typically use a passive splash lubrication system to oil gears, bearings, and other moving parts within the gearbox. In a splash lubrication system, a bottom-up approach is utilized to move oil within the gearbox. Oil resides in an oil pan at the bottom of the gearbox and a moving gear or dipper splashes oil up into the gearbox and onto other moving parts that, in turn, splash oil onto other moving parts located distally from the oil pan.

To quickly extinguish a large-scale fires in industrial or municipal environments, it is desirable to move the maximum amount of water available onto the burning combustibles in the shortest amount of time. High-capacity fluid pumps (e.g., at least about 5000 gal./min. at 150 psi) can move significantly greater amounts of water and other fluids in the same amount of time as compared to traditional, regular capacity fire pumps. In the context of a fire, this can help save valuable property and lives.

But high-capacity fluid pumps typically have significant power requirements and operate at increased temperatures and pressures. These factors contribute to greater wear of drive and pump components. Increased wear, in turn, reduces the useful life of the pump as well as increases both service downtime and component replacement costs. This increased wear in high-capacity fluid pumps has been traced to two primary causes: 1) inadequate lubrication within the pump's drive assembly; and 2) significant deflection of the fluid pump assembly components when operated at high rotational velocities. Moreover, high-capacity fluid pumps have been shown to be more susceptible to cavitation, pre-rotation, and turbulent flow at the pump inlet than traditional capacity fire pumps, thereby decreasing the overall efficiency of the fluid pump.

### SUMMARY

The high-capacity fluid pump of the present invention features a dedicated lubrication system in fluid communication with the pump's drive assembly to reduce wear of internal components within the gearbox, as well as a drive shaft-supported impeller and outboard head to reduce deflection within the fluid pump assembly as well as deflection of the fluid pump assembly with respect to the drive assembly. Moreover, the blades of the outboard head are preferably shaped to decrease the inlet's cross section, thereby reducing cavitation, pre-rotation, and turbulent flow at the pump inlet and increasing the overall velocity of incoming fluid. By incorporating a dedicated lubrication system, adequately supporting the impeller and outboard head of the fluid pump assembly, and reducing turbulent flow at the pump inlet, the high-capacity fluid pump of the present invention exhibits improved durability and efficiency compared to conventional high-capacity fluid pumps.

In an embodiment of the high-capacity fluid pump of the present invention, the lubrication system can comprise an oil pump for supplying oil or other lubricants at or near the gears, bearings, and other moving parts in need of lubrication. The lubrication system may further comprise a cooler to further reduce wear-inducing temperatures and prevent degradation of the lubricant.

For example, lubricant is preferably circulated through a drive assembly comprising gears. In one form, a lubricant pump draws lubricant from a lubricant collection container, such as an oil pan. The lubricant is preferably filtered and applied directly on, or proximate to, one or more gears, bearings, or other moving parts. Lubricant then falls back through the drive assembly, further lubricating other moving parts to which the lubricant comes in contact, until it collects in the lubricant collection container to repeat the cycle. In some forms, splash lubrication may supplement or act as a backup to the lubrication system.

In an embodiment of the high-capacity fluid pump of the present invention, the impeller may be supported and stabilized by positioning it on the drive shaft between a biasing member and a nut. The outboard head may be supported and stabilized by attaching the drive shaft to a sacrificial bushing housed within the outboard head.

In an embodiment of the high-capacity fluid pump of the present invention, the fluid pump can feature blades positioned at the inlet to help promote laminar flows by preventing pre-rotation and forcing fluid entering the inlet to adopt a straight path. Drag caused by the blades is reduced by curving the side of the blades facing the incoming fluid. Moreover, the shape of the fluid pump inlet itself, such as an outboard head, can also increase performance and efficiency by accelerating fluid into an impeller eye, further reducing pre-rotation and, in effect, “turbocharging” the impeller. Because the velocity of a given volume of fluid increases as its cross section decreases, the cross section of the inlet is preferably smaller than the pump's fluid connection to a tank or other fluid source.

For example, an inlet may be divided into two or more apertures by one or more blades having a length. The length of the blades is longitudinal to the flow of fluid entering the inlet. The blades prevent pre-rotation by dividing the inflowing fluid and preventing the fluid from rotating about a central axis. Blades and a central member may be preferably positioned within the inlet to decrease the inlet's cross section, thereby increasing the velocity of incoming fluid.

The invention may take many forms. For example, in a first foini, a high-capacity water pump may comprise a drive assembly; a fluid pump assembly; and a lubrication system. The drive assembly may comprise an input drive, a output drive shaft, and at least one gear or bearing. The fluid pump assembly may comprise a head comprising an inner diameter, three or more fixed blades, a central nose comprising a cavity shaped to house a rotatable sacrificial bushing, and an inlet, wherein the inlet consists of three or more apertures defined by the inner diameter, nose, and blades; an impeller, and a volute comprising an outlet. In one form, the output drive shaft is operably connected to the impeller and attached to the sacrificial bushing, thereby providing a force at a distal end of the output drive shaft resisting deflection of the head. Forces that can lead to such deflection include the weight of the fluid pump assembly itself, the immense horsepower applied to the fluid pump assembly by the drive assembly, and the reactive force of the water exiting the fluid pump assembly. The lubrication system is preferably in fluid communication with the drive assembly, and a lubricant flow path preferably includes at least a lubricant pump and the at least one gear or bearing. A water flow path preferably includes at least the inlet, impeller, and outlet. The blades are preferably shaped to prevent pre-rotation of incoming water, such that there is substantially laminar flow across at least a portion of the inlet.

In a second form, a pump may comprise a drive assembly with a drive shaft; a fluid pump assembly; and a lubrication system. The lubrication system is preferably in fluid communication with the drive assembly and may comprise a lubricant pump. The fluid pump assembly comprising an inlet with a head, wherein the head comprises at least one fixed blade dividing the head into least two apertures. The head may be supported by an end of the drive shaft.

In a third form, an apparatus for moving fluid may comprise a gearbox and a lubrication system. The lubrication system is preferably in fluid communication with the gearbox. Lubricant may be pressurized and adopt a flow path including one or more of the following: a filter, a lubricant pump, a cooler, a splitter, a gearbox inlet port, at least one gear or bearing, a lubrication container positioned at a base of the gearbox, and a gearbox outlet port. The gearbox may operably coupled to a fluid pump having a maximum flow rate of at least 2500 gal./min., more preferably at least 3000 gal./min. and most preferably 5000 gal./min.

In a fourth form, a system for moving fluid may comprise a drive shaft and a fluid pump assembly. The fluid pump assembly may comprise an inlet and a head, wherein the head comprises at least one fixed blade dividing the head into least two apertures. The inlet head is preferably supported by an end of the drive shaft.

In a fifth form, a method may comprise pumping lubricant to a first end of a drive assembly; circulating lubricant through a lubricant collection container positioned at a second end of the drive assembly; and filtering the lubricant.

In a six form, a method may comprise rotating an impeller; drawing fluid into an inlet having one or more blades; and preventing pre-rotation across at least a portion of the inlet.

In any or all of the foregoing forms and embodiments, the fluid pump may have a maximum flow rate of at least 2500 gal./min., more preferably at least 3000 gal./min., and most preferably 5000 gal./min. or greater.

In any or all of the foregoing forms and embodiments, an impeller may be positioned on a drive shaft between a biasing member and a support member, wherein the impeller is positioned on the drive shaft such that the biasing member is at least partially compressed. A head may be supported by an end of the drive shaft.

In any or all of the foregoing forms and embodiments, lubricant is preferably filtered. A flow path may include at least the lubricant pump and at least one moving part within the drive assembly. The flow path may further include a lubricant filter.

In any or all of the foregoing forms and embodiments, an inlet, and portions thereof, is preferably shaped to prevent pre-rotation of water entering the inlet. For example, the blades may be shaped to substantially reduce pre-rotation of fluid around a central axis of the inlet. One way to achieve this is by having the blade have a length in a direction orthogonal to a plane of the inlet, wherein the length is sufficient to substantially reduce pre-rotation of fluid around a central axis of the inlet. Exact sizes will depend on the size of the pump. The inlet preferably has a cross section smaller than the cross section of a proximate portion of the connection to the fluid source. For example, the head may comprise three blades and a central support member.

In any or all of the foregoing founs and embodiments, a head may comprises a cavity shaped to house a rotatable sacrificial bushing, and wherein the output drive shaft is attached to the sacrificial bushing.

The above summary is not intended to describe each illustrated embodiment or every possible implementation. It is not an exhaustive overview of the details disclosed herein. Nor is it intended to identify key or critical elements of the invention or to delineate the scope of the invention. These and other features, aspects, and advantages of the subject matter of this disclosure will become better understood in view of the following description, drawings, and claims.

### BRIEF DESCRIPTION OF THE DRAWINGS

The accompanying figures, where like reference numerals refer to identical or functionally similar elements throughout the separate views, and which, together with the detailed description below, are incorporated in and form part of the specification, serve to illustrate further various embodiments and to explain various principles and advantages in accordance with the present invention:

FIG. 1 is a front perspective view of one embodiment of a pump in a split drive configuration.

FIG. 2 is a rear perspective view of the pump of FIG. 1.

FIG. 3 is an exploded view of the pump of FIG. 1.

FIGS. 4A-B are lubricant flow diagrams.

FIG. 4C is a coolant flow diagram.

FIG. 5 is a front perspective view of one embodiment of a pump in a direct drive configuration.

FIG. 6 is a rear perspective view of the pump of FIG. 5.

FIG. 7A is an exploded view of one embodiment of an output drive assembly and fluid pump assembly.

FIGS. 7B-C are front and rear views of the outboard head of FIG. 7A.

FIG. 7D is a detail view of FIG. 7C.

FIG. 8 is a cross section of one embodiment of a fluid pump assembly.

### DESCRIPTION OF REFERENCE NUMERALS

100 . . . high-capacity pump

150 . . . motor

160 . . . tank

200 . . . drive assembly

205 . . . gearbox

210 . . . pressure release valve

220 . . . front input drive

221 . . . input drive housing

222 . . . input drive gear

223 . . . input drive cap

230 . . . transmission assembly

232 . . . transmission shifter

234 . . . transmission shaft

240 . . . accessory drive

241 . . . accessory drive cap

242 . . . accessory drive gear

250 . . . upper output drive

251 . . . upper output drive cap

252 . . . upper output gear

253 . . . upper output bearing assembly

254 . . . drive shaft

254a . . . threaded portion of drive shaft 254

255 . . . nut

260 . . . idler gear

270 . . . lower output drive

300 . . . lubrication system

302 . . . gearbox inlet port

303 . . . gearbox outlet port

304 . . . hose

310 . . . lubricant pump

312 . . . lubricant pump inlet hose

314 . . . lubricant pump outlet hose

316 . . . lubricant collection container

318 . . . lubricant filter

320 . . . directional port

330 . . . splitter

332 . . . pressure sensor

333 . . . pressure sensor line

334 . . . pressure gauge

340 . . . cooler

342 . . . cooler inlet hose

344 . . . cooler outlet hose

346 . . . cooler inlet port

348 . . . cooler outlet port

400 . . . fluid pump assembly

410 . . . inboard head

420 . . . impeller

430 . . . volute

432 . . . pump outlet

433 . . . aperture for cooler outlet hose 344

440 . . . outboard head

442 . . . central support member

443 . . . first side (curved), nose

444 . . . sacrificial bushing

445 . . . blade

446 . . . first side (curved)

447 . . . second side (flat)

448 . . . aperture for fluid entering volute 430

450 . . . O-ring

452 . . . gasket

454 . . . wear ring

456 . . . biasing member

457 . . . seal

### DESCRIPTION

A high-capacity fluid pump featuring a dedicated lubrication system and stabilized fluid pump assembly components is described herein. The description which follows, and the embodiments described therein, is provided, by way of illustration of examples of particular embodiments of principles and aspects of the present invention. These examples are provided for the purposes of explanation and not of limitationof those principles of the invention. In the description that follows, like parts are marked throughout the specification and the drawings with the same respective reference numerals. As used herein, the term “about” or “approximately” applies to all numeric values, whether or not explicitly indicated. These terms generally refer to a range of numbers that one of skill in the art would consider equivalent to the recited values (i.e., having the same function or result). In many instances these temis may include numbers that are rounded to the nearest significant figure. Relational terms such as first and second, top and bottom, right and left, and the like may be used solely to distinguish one component or feature from another component or feature without necessarily requiring or implying any actual such relationship or order between such components and features.

A high-capacity pump 100 designed according to this disclosure may benefit from reduced wear and increased efficiency. Pump 100 may comprise a drive assembly 200, lubrication system 300, and fluid pump assembly 400.

A dedicated lubrication system 300 can help reduce wear in a drive assembly 200. Lubrication system 300 preferably pumps lubricant directly on or proximate to gears, bearings, and other moving parts within drive assembly 200. If lubrication system 300 comprises a lubrication collection container 316, such as an oil pan, splash lubrication can operate in parallel with the lubrication system 300 and acts as a backup. Optimal lubrication can reduce wear and promote uniformity of wear across components while increasing their useful life. A lubrication system 300 comprising a cooler 340 can further reduce wear-inducing temperatures and prevent lubricant degradation.

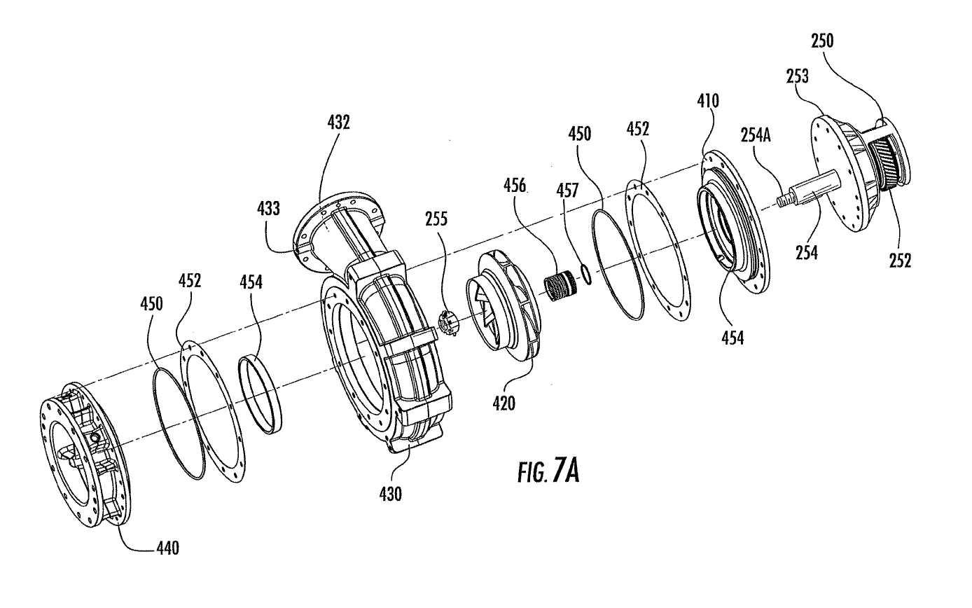

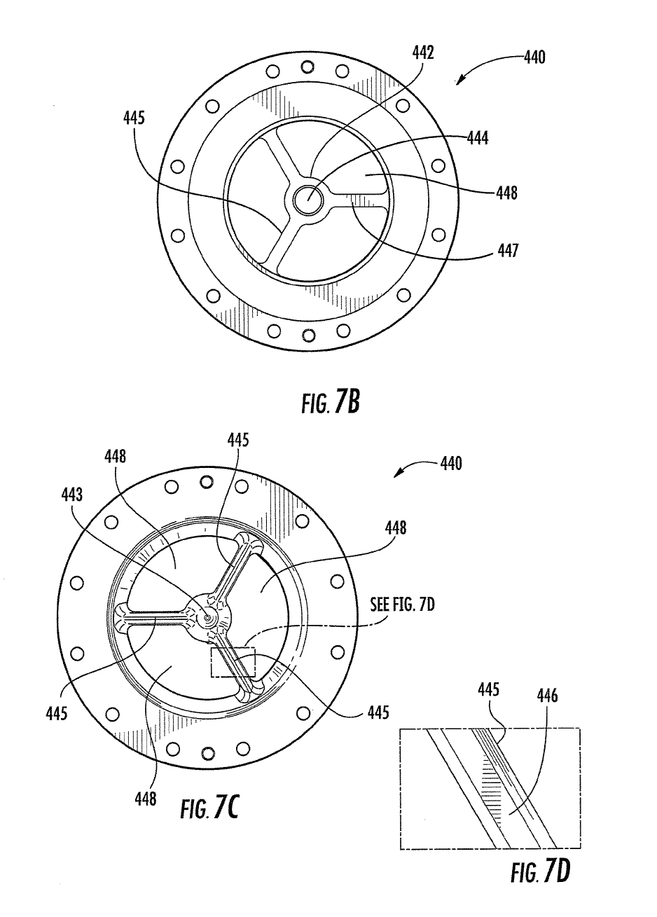

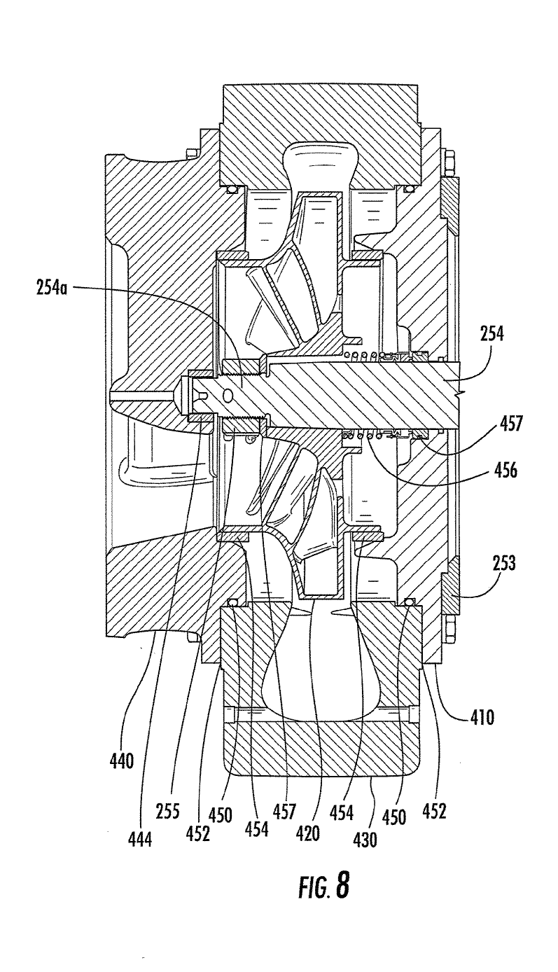

Wear may be further reduced within an adequately supported and stabilized fluid pump assembly 400. As shown in FIGS. 7A and 8, fluid pump assembly 400 comprises an impeller 420 and outboard head 440. In one embodiment, impeller 420 is rotated by a drive shaft 254, which has a threaded portion 254a. Impeller 420 is positioned on drive shaft 254 between a biasing member 456 and a nut 255, which engages threaded portion 254a. Because nut 255 has a greater outer diameter than an inner diameter of the impeller 420, tensioning nut 255 loads (e.g., compresses) biasing member 456 and thereby stabilizes the impeller 420, preventing deflection. In this or an alternative embodiment, drive shaft 254 also supports and stabilizes outboard head 440. Head 440 comprises central support member 442 housing a sacrificial bushing 444 that is engaged to the threaded portion 254a.

Increased efficiency may be achieved by increasing laminar flows of fluid across the inlet of fluid pump assembly 400. In one embodiment, the outboard head 440 comprises one or more blades 445 that prevent pre-rotation of fluid entering the inlet. In some forms, central support member 442 comprises a nose member 443 that is curved and to which blades 445 are connected. Blades 445 may also have a curved side 446 facing fluid entering the inlet, reducing drag.

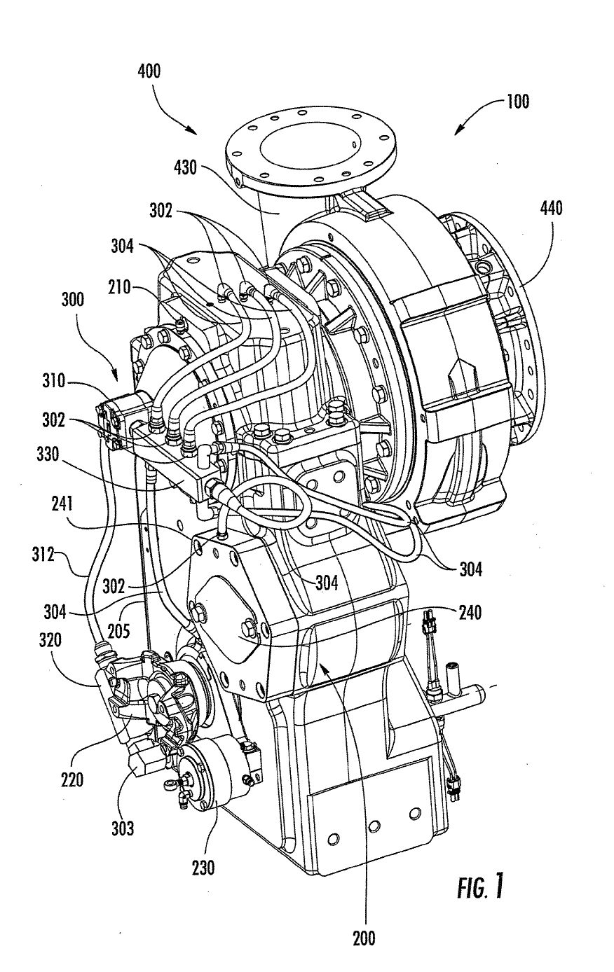

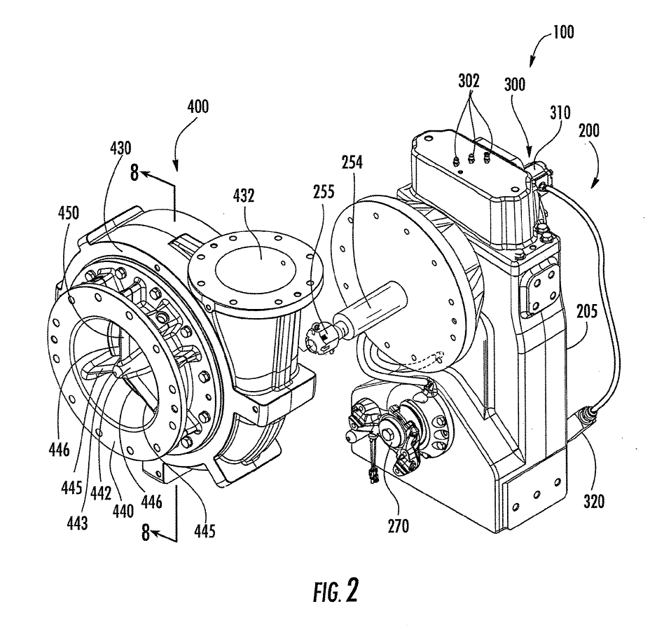

Turning to the figures, FIGS. 1 and 2 show one form of a high-capacity pump 100 in a split drive configuration suitable for installation on a fire apparatus (not shown), e.g., a fire truck. The pump 100 comprises a drive assembly 200, a lubrication system 300, and fluid pump assembly 400.

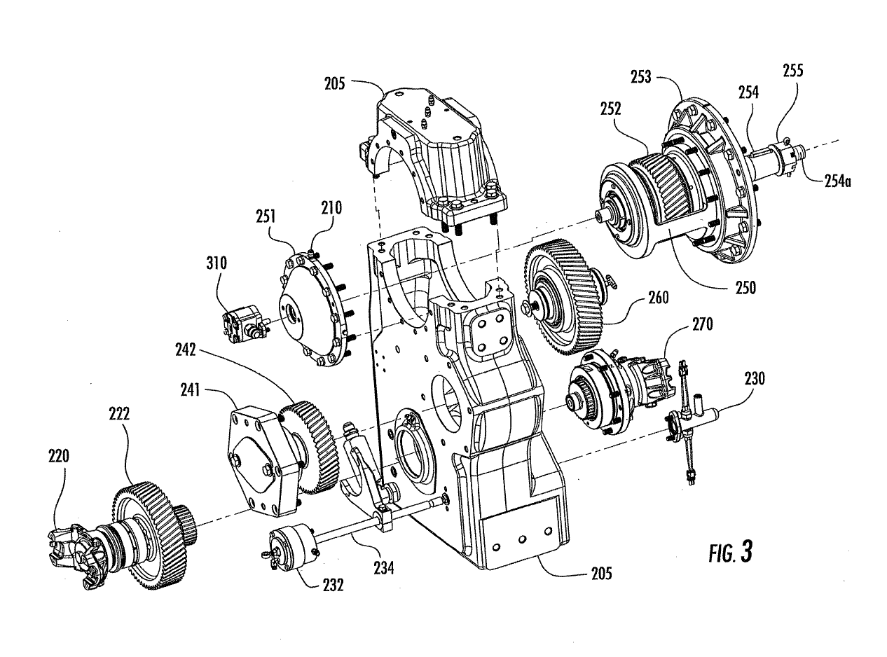

The split drive configured drive assembly 200 is shown in an exploded view in FIG. 3. The motor of a fire apparatus (not shown) may be operably coupled to front input drive 220 to rotate input drive gear 222. Transmission assembly 230, including transmission shifter 232 and transmission shaft 234, causes the input drive gear 222 to engage either lower output drive 270, accessory drive gear 242, or idler gear 260. Lower output drive 270 may be operably coupled to an axle (not shown) to turn the wheels of a fire apparatus. The accessory drive 240 is optional and may be coupled to a shaft (not shown) or other device to operate fire apparatus accessories, such as a hydraulic pump to drive a foam system or air compressor. Because idler gear 260 may engage both input drive gear 222 and upper output gear 252, it is preferably sized to optimize the operation of fluid pump assembly 400. (This gear ratio is a function of the horsepower of the motor and the operational requirements of the fluid pump assembly 400.) Upper output gear 252 rotates drive shaft 254.

The drive assembly 200 may also comprise a gearbox 205. The gearbox 205 is preferably sealed such that a pressure within gearbox 205 may be greater than atmospheric pressure. The gearbox 205 may comprise pressure release valve 210, accessory drive cap 241, and upper output drive cap 251.

One form of a lubrication system 300, shown in FIGS. 1-3 and 4A, comprises an oil pump 310. Oil pump 310 is directly connected to splitter 330, which distributes pressurized lubricant across hoses 304. The lubrication system 300 also comprises an oil filter 318 (not shown) positioned in or in fluid communication with an oil pan 316 (not shown).

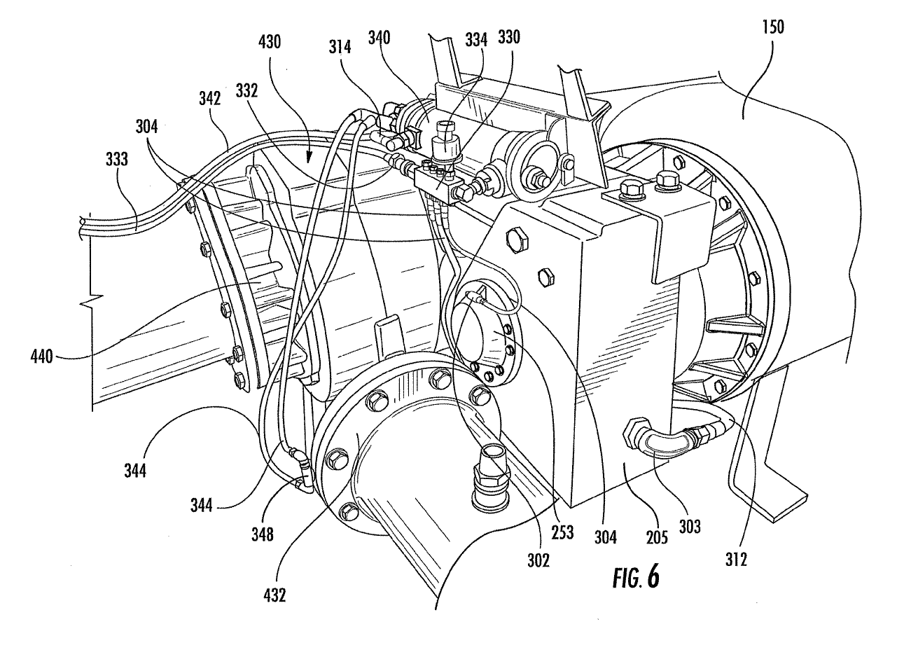

Another form of a high-capacity pump 100, shown in FIGS. 5-6, may be in a direct drive configuration suitable for stationary or mobile applications with a dedicated motor 150. The pump 100 comprises a drive assembly 200, a lubrication system 300, and fluid pump assembly 400.

The drive assembly 200 comprises a gearbox 205, an input drive 220, a gear 260, and an output drive 250. The size of gear 260 is a function of the horsepower of the motor and the operational requirements of the fluid pump assembly 400. The gearbox comprises an input drive housing 221, an input drive cap 223, and an output drive cap 251.

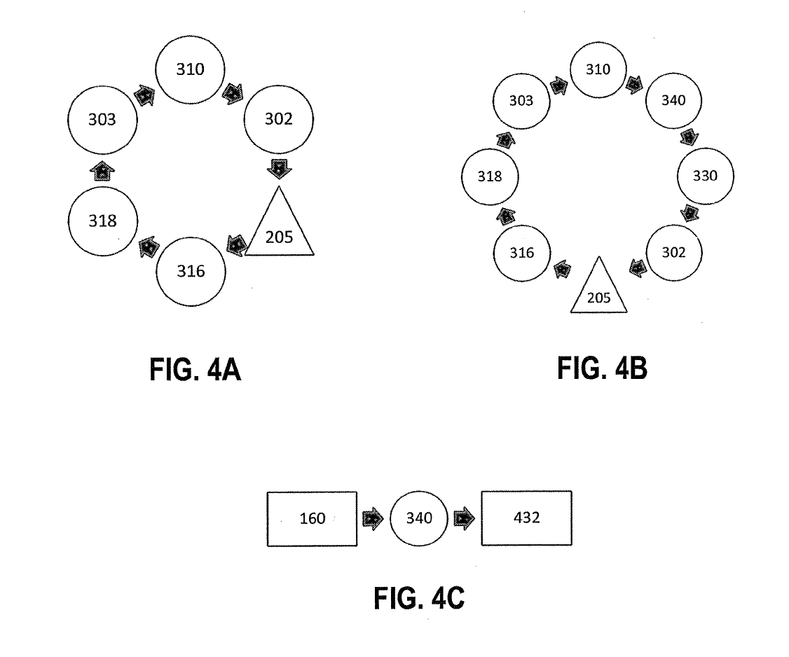

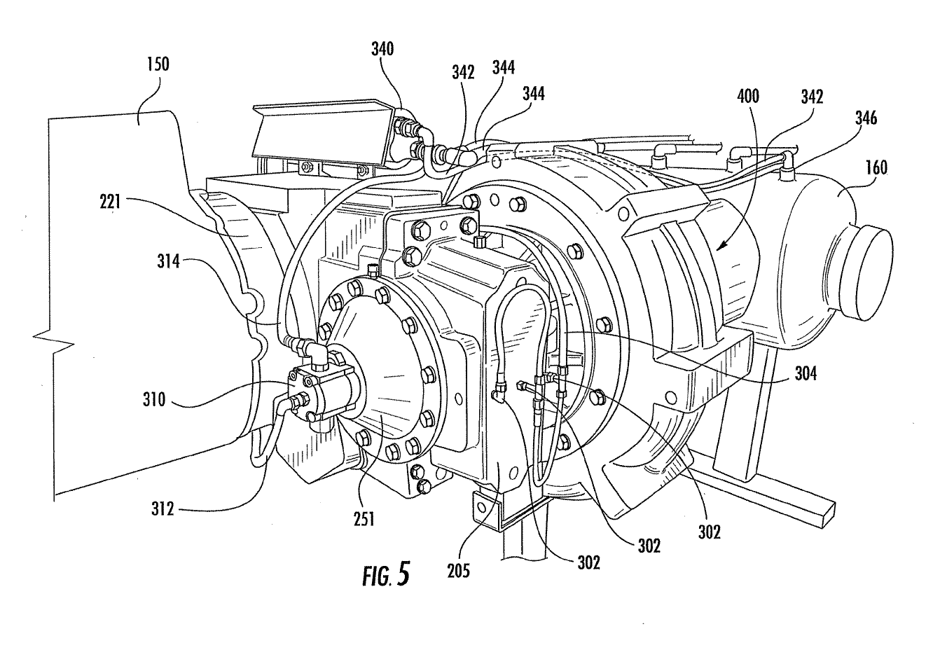

As shown in FIGS. 5-6 and 4B-C, another form of a lubrication system 300 comprising an oil pump 310 and a cooler 340. Oil pump 310 is connected to cooler 340, which is connected to splitter 330. In this embodiment, cooler 340 circulates water and is connected to water tank 160 and water pump outlet 432. The lubrication system 300 also comprises an oil filter 318 (not shown) positioned in or in fluid communication with an oil pan 316 (not shown).

If an oil pump 310 is located outside gearbox 205 as shown in FIGS. 1-3 and 5-6, the gearbox 205 may also comprise apertures for gearbox inlet nozzles 302 and gearbox outlet nozzles 303. The apertures for gearbox inlet nozzles 302 are preferably positioned at or near gears or other moving parts of drive assembly 200. The aperture for gearbox outlet nozzle 303 is preferably positioned near a lubrication collection container, such as an oil pan.

For example, as shown in FIGS. 1-3, the gearbox 205 comprises seven apertures for gearbox inlet nozzles 302 located proximally to front input drive 220 (one aperture), accessory drive 240 (one aperture), upper output drive 250 (three apertures), idler gear 260 (hidden, one aperture), and lower output drive 270 (one aperture). By contrast, FIGS. 5-6 shows gearbox 205 with five apertures for gearbox inlet nozzles 302 located proximally to an output drive (three apertures), idler gear 260 (hidden, one aperture), an input drive cap 223 (one aperture).

Forms of the fluid pump assembly 400 are shown in 1-2, 5-6, 7A-D and 8 and are suitable for both split drive, direct drive, and other configurations. As shown in FIGS. 7A and 8, a fluid pump assembly 400 may comprise an inboard head 410, an impeller 420, a volute 430, and an outboard head 440.

One way to couple a drive assembly 200 to a fluid pump assembly 400 is through the attachment of upper output bearing assembly 253 to inboard head 410. Mechanical seal 457 preferably forms a fluid impermeable seal between fluid pump assembly 400 and drive assembly 200, preventing water or other fluid from entering drive assembly 200 and preventing lubricant from entering fluid pump assembly 400. Seal 457 is a wear component that should be replaced from time to time.

Gaskets 452 and O-rings 450 seal attachments between the volute 430 and inboard head 410 and outboard head 440. Wear rings 454 are positioned between the impeller 420 and inboard head 410 and outboard head 440. Wear rings 454 are wear components that should be replaced from time to time.

Drive shaft 254 rotates impeller 420. Drive shaft 254 comprises a non-threaded portion (which may comprise a notch to engage impeller 420) and a threaded portion (254a). A biasing member 456, such as a spring, may be positioned on the non-threaded portion proximate to inboard head 410. Nut 255 may engage threaded portion 254a of drive shaft 254 proximate to outboard head 440. Impeller 420 may be positioned between and abut biasing member 456 and nut 255, such that tightening nut 255 loads biasing member 456 and stabilizes impeller 420. Nut 255 may be a jack nut and is preferably formed from a material that is softer than the material composing the impeller 420; for example, if impeller 420 is steel, nut 255 may be brass.

As shown in FIGS. 2 and 7B-D, outboard head 440 has a first side and second side. On the first side of outboard head 440, best seen in FIGS. 2 and 7C-D, head 440 comprises an inlet of three apertures 448. The inlet is defined by an inner diameter of the outboard head 440 divided by a central support member 442 (with a curved nose 443) connected to three blades 445, each preferably having a substantially curved side 446.

On the second side of outboard head 440, as shown in FIG. 7B, the central support member 442 has a cavity that houses a sacrificial bushing 444. The second side 447 of blades 445 are preferably substantially flat (i.e., not curved). Onboard head 440 is attached to volute 430 and sacrificial bushing 444 is attached to threaded portion 254a of drive shaft 254.

Sacrificial bushing 444 supports outboard head 440 and prevents deflection of the fluid pump assembly 400. Sacrificial bushing 444 rotates with drive shaft 254 and a thin film of fluid separates it from central support member 442. Sacrificial bushing 444 is preferably formed from a material that is softer than the material composing the central support member 442; for example, if central support member 442 is steel, sacrificial bushing 444 may be brass.

Blades 445 prevent pre-rotation of fluid entering the inlet of outboard head 440 and promote laminar flow across the inlet and into the impeller 420. Blades 445 preferably have a length equal to or less than the length of outboard head 440 (measured along its central axis).

Various founs of the invention may have various flow paths for fluids moving through or within the high-capacity pump 100, including fluid moving through fluid pump assembly 400, lubricant moving within drive assembly 200 and lubrication system 300, and/or coolant moving through cooler 340.

One method of moving fluid through a high-capacity pump 100 comprises rotating an impeller 420. Impeller 420 creates low pressure at an inlet of fluid pump assembly 400 (within head 440), causing fluid to move from a tank 160 through the inlet and into impeller 420. Impeller 420 accelerates the fluid by applying a centrifugal force on the fluid within a volute 430. Fluid exits at high speed and pressure at pump outlet 432 (within volute 430).

One method of moving lubricant within drive assembly 200 comprises pumping lubricant from an oil pan 316. In one embodiment, see FIG. 4A, oil pump 310 draws lubricant through filter 318 positioned in or in fluid communication with oil pan 316, out gearbox outlet port 303, through oil pump 310, across one or more gearbox inlet ports 302, and into gearbox 205. In another embodiment, see FIG. 4B, oil pump 310 draws lubricant through filter 318 positioned in or in fluid communication with oil pan 316, out gearbox outlet port 303, through oil pump 310, cooler 340, and splitter 330, across one or more gearbox inlet ports 302, and into gearbox 205. In both embodiments, once within the gearbox 205, the lubricant lubricates gears, bearings, and other moving parts until the lubricant flows to oil pan 316 and the cycle is repeated. Splash lubrication may proceed concurrently with the lubrication system 300. As shown in FIGS. 1-2 and 5-6, lubricant may also move through directional port 320, pump inlet hose 312, pump outlet hose 314, splitter 330 and/or cooler 340.

One method of moving coolant, such as water or other suitable fluid, through a lubrication system 300 comprises pumping coolant and lubricant across a heat exchanger within a cooler 340. In one embodiment, see FIG. 4C, coolant may flow from tank 160, through cooler 340, and out pump outlet 432. In another embodiment, see FIGS. 5-6, water may flow from tank 160, into cooler inlet port 346, through cooler inlet hose 342, across a heat exchanger to absorb heat from the lubricant, through cooler outlet hoses 344, and out cooler outlet port 348 to pump outlet 432.

### PROPHETIC EXAMPLE 1

In a split drive configuration (see FIGS. 1-3, 7A-D, and 8), about 5000 to 6500 gal./min. flows through fluid pump assembly 400, entering through outboard head 440, and exiting through pump outlet 432. A fire apparatus with about 600 to 700 horsepower rotates—through drive assembly 200 and front input drive 220—impeller 420, which has an angular velocity of about 2000 to 2400 rotations per minute. Lubrication system 300 is in fluid communication with drive assembly 200 and operates at pressures ranging from about 15 to 30 psi.

### PROPHETIC EXAMPLE 2

In a direct drive configuration (see FIGS. 5-8), about 5000 to 6500 gal./min. flows through fluid pump assembly 400. An engine 150 with about 600 to 800 horsepower engages—through drive assembly 200—impeller 420, which has an angular velocity of about 2000 to 2400 rotations per minute. Lubrication system 300 is in fluid communication with drive assembly 200 and operates at pressures ranging from about 15 to 30 psi.

### PROPHETIC EXAMPLE 3

In either or both of the foregoing examples, lubrication system 300 may also comprise cooler 340 to maintain operating lubrication temperatures below about 180° F.

Many components described in this disclosure may be optional, regardless of whether they are identified as such. For illustrative purposes, however, some components may be optional or unnecessary depending on the application for which the pump 100 will be used.

For example, unlike the drive assembly 200 of FIGS. 1-3, the drive assembly 200 of FIGS. 5-6 does not have an accessory drive 240, a lower output drive 270, or a transmission assembly 230. These are optional components for certain applications.

Likewise, some lubrication systems 300 may not comprise a splitter 330 (see FIG. 4A) or a filter 318. Further, in some embodiments, all or part of the lubrication systems 300 may be located within a gearbox 205, eliminating the need for gearbox inlet ports 302 and gearbox outlet port 303.

While specific embodiments have been described above, many alternative embodiments may be suitable in view of the objects of the foregoing disclosure.

Although the pump 100 lends itself to large-scale industrial firefighting applications, it could also be used in a municipal setting.

In alternative embodiments, each drive component with a single aperture for a gearbox inlet port 302 may have plural apertures for plural ports 302. Alternatively, a drive component having plural apertures for plural ports 302 may only have one at that location on the gearbox 205; in which case, the single gearbox inlet port 302 preferably has a wide spraying nozzle to maximize distribution of lubricant within gearbox 205.

Numerous modifications, substitutions, and omissions may be made to the order of flow within a lubrication system 300. For example, filter 318 may be located outside gearbox 205; FIG. 4A would be modified to show: 205→316→303→318→310→302→205. Numerous alternative orders exist and all are within the scope of this disclosure. Indeed, directional ports 320, splitters 330, and coolers 340 may be interposed almost anywhere between an oil pump 310 and gearbox 205; or they may be omitted.

Under appropriate conditions, all or part of the lubrication systems 300 of either of the illustrative high-capacity pumps 100 shown may be substituted for the other. For example, the lubrication system 300 of FIGS. 1-3 (without cooler and/or additional hoses 304) may be substituted with suitable modifications for the lubrication system 300 of FIGS. 5-6 (with cooler 340 and/or fewer hoses 304) for the high-capacity pump 100 of FIGS. 5-6. And vice versa.

Cooler 340 may circulate a fluid other than water, such as radiator fluid, refrigerant, or other suitable fluid.

Any container suitable for holding oil or other lubricant may serve as an oil pan or lubrication collection pan or container, including a portion of the gearbox 205 itself.

Blades 445 may have two flat sides, two curved sides, or some blades may have curved or flat sides while others may or may not.

Finally, many fluid pumps (including high, regular, and smaller capacity pumps) may be retrofitted with all or part of lubrication system 300, and/or with all or some of the components supporting and stabilizing the fluid pump assembly 400, and/or an inlet with one or more blades 445. One of ordinary skill with the benefit of this disclosure would know what modifications, if any, would be necessary to retrofit such existing or future developed systems.

The foregoing description of the embodiments of the invention has been presented for purposes of illustration and description. It is not intended to be exhaustive or to limit the invention to the precise form(s) disclosed, and many modifications and other embodiments of the invention set forth in this disclosure will be appreciated by one skilled in the art having the benefit of this disclosure. The embodiments were chosen and described in order to explain the principles of the invention and its practical application to enable one skilled in the art to utilize the invention in various embodiments and with various modifications as are suited to the particular use contemplated. The embodiments shown in the drawings and described above are exemplary of numerous embodiments that may be made within the scope of the appended claims. It is contemplated that numerous other configurations may be used, and the material of each component may be selected from numerous materials other than those specifically disclosed.

It will be appreciated that in the development of a product or method embodying the invention, the developer must make numerous implementation-specific decisions to achieve the developer's specific goals, such as compliance with manufacturing and business-related constraints, that will vary from one implementation to another. Moreover, it will be appreciated that such a development effort may be complex and time-consuming, but would nevertheless be a routine undertaking for those of ordinary skill in the art having the benefit of this disclosure.

This disclosure does not contain a glossary. No special definition of a term or phrase, i.e., a definition that is different from the ordinary and customary meaning as understood by those skilled in the art, is intended to be implied by consistent usage of the term or phrase herein. Words and phrases should be understood and interpreted to have a meaning consistent with the understanding of those words and phrases by those skilled in the relevant art and case law. For example, an embodiment comprising a singular element does not disclaim plural embodiments; i.e., the indefinite articles “a” and “an” carry either a singular or plural meaning and a later reference to the same element reflects the same potential plurality. A structural element that is embodied by a single component or unitary structure may be composed of multiple components. Ordinal designations (first, second, third, etc.) merely serve as a shorthand reference for different components and do not denote any sequential, spatial, or positional relationship between them. Words of approximation such as “about,” “approximately,” or “substantially” refer to a condition or measurement that, when so modified, is understood to not necessarily be absolute or perfect but would be considered close enough by those of ordinary skill in the art to warrant designating the condition as being present or the measurement being satisfied. For example, a numerical value or measurement that is modified by a word of approximation, such as “about” or “approximately,” may vary from the stated value by 1, 2, 3, 4, 5, 6, 7, 10, 12, and up to 15%.

It is intended that the scope of the invention be defined only by the following claims, as amended, and their equivalents.

1. A high-capacity water pump comprising:
a. a drive assembly comprising a drive shaft operatively coupled to a gearbox., wherein the gearbox comprises a plurality of gears;
b. a fluid pump assembly operatively coupled to the drive assembly, the fluid pump assembly comprising: a volute, an outboard head attached to the volute, and an impeller positioned within the volute and coupled to the drive shaft;
c. a lubrication system in fluid communication with the gearbox, the lubrication system comprising: an oil pump; a plurality of gearbox inlet nozzles each positioned proximate to one of the plurality of gears; and a plurality of hoses connecting the oil pump to the plurality of gearbox inlet nozzles.

2. The pump of claim 1, wherein the lubrication system further comprises a splitter, the splitter operatively connecting the oil pump to the plurality of hoses.

3. The pump of claim 2, wherein the lubrication system further comprises a cooler, the cooler operatively connecting the oil pump to the splitter.

4. The pump of claim 1, wherein the outboard head comprises an annular inlet subdivided into a plurality of apertures by a plurality of fixed blades extending from a central nose, the central nose comprising a cavity.

5. The pump of claim 4, wherein a distal end of the drive shaft extends into the cavity of the central nose, and wherein the drive assembly further comprises a sacrificial bushing mounted to the distal end of the drive shaft.

6. A pump comprising:
a. a drive assembly comprising a drive shaft operatively coupled to a gearbox, wherein the gearbox comprises one or more gears;
b. a lubrication system in fluid communication with the drive assembly, wherein the lubrication system comprises a lubricant pump; and
c. a fluid pump assembly comprising a head with an inlet, wherein the head further comprises at least one blade extending from a central nose and dividing the inlet into at least two apertures, and wherein a distal end of the drive shaft extends into a cavity formed in the central nose.

7. (canceled)

8. The pump of claim 6, wherein the lubrication system further comprises one or more gearbox inlet nozzles positioned proximate to the one or more gears.

9. The pump of claim 8, wherein the lubrication system further comprises one or more hoses connecting the lubricant pump to the one or more gearbox inlet nozzles.

10. The pump of claim 6, wherein the drive assembly further comprises a sacrificial bushing mounted to the distal end of the drive shaft.

11. A pump comprising:
a. a drive assembly comprising a drive shaft;
b. a lubrication system in fluid communication with the drive assembly, wherein the lubrication system comprises a lubricant pump; and
c. a fluid pump assembly comprising a head with an inlet, wherein the head comprises:
i. at least one blade dividing the inlet into at least two apertures, and;
ii. a cavity shaped to house a rotatable sacrificial bushing, wherein the drive shaft is attached to the sacrificial bushing.

12. (canceled)

13. (canceled)

14. (canceled)

15. The pump of claim 11, wherein the at least one blade has a length in a direction orthogonal to a plane of the inlet for reducing pre-rotation of fluid around a central axis of the inlet.

16. The pump of claim 11, wherein the fluid pump assembly further comprises an impeller positioned on the drive shaft between a biasing member and a support member, and wherein the impeller is positioned on the drive shaft such that the biasing member is at least partially compressed.

17. (canceled)

18. (canceled)

19. (canceled)

20. (canceled)
